(19) United States
(12) Patent Application Publication
(10) Pub. No.: US 2026/0095086 A1
(43) Pub. Date: Apr. 2, 2026

(54) POWER SUPPLY AND CONTROL METHOD THEREOF

(71) Applicant: ACBEL POLYTECH INC., New Taipei City (TW)

(72) Inventor: Cheng-Hsiao LUO, New Taipei City (TW)

(73) Assignee: ACBEL POLYTECH INC., New Taipei City (TW)

(21) Appl. No.: 18/901,171

(22) Filed: Sep. 30, 2024

(51) Int. Cl. H02M 1/00

(52) U.S. Cl. CPC H02M 1/0025

(57) ABSTRACT

The present invention discloses a power supply and a control method thereof. The power supply comprises a power conversion unit, a current sampling circuit, and a signal comparison unit. The power conversion unit converts a power source based on an input power source, generates an output current, has a power source output terminal, and outputs the output current from the power source output terminal. The current sampling circuit samples a transient variation of the output current and to generate an output voltage difference signal corresponding to the transient variation. The signal comparison unit is electrically connected to the current sampling circuit, receives the output voltage difference signal, and compares the output voltage difference signal with a predetermined voltage value. When the output voltage difference signal is greater than or equal to the predetermined voltage value, the signal comparison unit generates a dynamic compensating command.

### BACKGROUND OF THE INVENTION

### 1. Field of the Invention

The present invention relates to a power supply and a control method thereof, particularly to a power supply and a control method thereof utilizing a feedback current signal as a trigger control command for generating a compensation command when an output current of a dynamic response has been abruptly varied.

### 2. Description of the Related Art

Refer to FIG. 5A. FIG. 5A is a circuit diagram of a conventional server power supply circuit for detecting an output dynamic response. The conventional server power supply circuit for detecting the output dynamic response comprises a power converter 21, an output capacitor Cₒᵤₜ, a load resistor R_{L}, a divider resistor 22, and an analog/digital proportional-integral controller 23. The power converter 21 is electrically connected to a input power P, transfers an input signal of the input power P, and transmits the input signal to the output capacitor Cₒᵤₜ and the load resistor R_{L}. The divider voltage V_{FB} is generated by the output voltage Vₒᵤₜ across the load resistor R_{L} being divided by the divider resistor 22 and inputted to the analog/digital proportional-integral controller 23. The conventional method for detecting the dynamic load response usually measures the output voltage Vₒᵤₜ. When the output voltage Vₒᵤₜ is hugely drawn, the output voltage Vₒᵤₜ across the load port descends. After the output voltage Vₒᵤₜ across the load port descends, the server power supply circuit for detecting the output dynamic response needs to detect a variance of the output voltage Vₒᵤₜ in real time so that the server power supply circuit increases the output voltage Vₒᵤₜ when the output voltage Vₒᵤₜ is decreased.

As mentioned above, in the circuit of FIG. 5A, after the divider voltage V_{FB} is generated by dividing the output voltage Vₒᵤₜ across the divider resistor 22, a command is generated according to the divider voltage V_{FB}. Therefore, after the command is inputted to the analog/digital proportional-integral controller 23, the variance of the output voltage Vₒᵤₜ is detected according to the divider voltage V_{FB} by the circuit. At the period, the circuit compensates the output voltage Vₒᵤₜ. However, since a response speed of the voltage loop feedback controller is limited to a bandwidth of the voltage loop feedback controller, the circuit using a voltage loop feedback controller in FIG. 5A fails to detect a dynamic response for the variance of the output voltage Vₒᵤₜ in real time to improve the control signal. Therefore, the circuit using a voltage loop feedback controller fails to be widely used. In other words, the response speed of the voltage loop feedback controller is limited to the bandwidth. Recently, a drawing speed for drawing an output current has been upgraded form 0.5 A/μs to 2.5 A/μs even to 10 A/μs. However, when the drawing speed is getting higher and higher, the circuit utilizing an analog/digital proportional-integral controller to detect the variance of the output voltage has failed to follow the drawing speed.

Refer to FIG. 5B and FIG. 5C. FIG. 5B is the simulation circuit of the voltage loop feedback signal in FIG. 5A, and FIG. 5C is the schematic diagram for the circuit bandwidth relative to the drawing speed of the current in FIG. 5A. As shown in FIG. 5B, the simulation circuit utilizes a server power supply to supply power to the output capacitor. The drawing speed of the output current is 2.5 A/μs, from 0 ampere to 100 ampere. In addition, FIG. 5B represents an analysis simulation for various bandwidths BW, wherein a curve of BW_2k represents a well-known bandwidth of 2 kHz and a curve of BW_44k represents a desired bandwidth derived from a calculation. As shown in FIG. 5C, since the most part of the bandwidth of the voltage loop feedback controller is between 2K (BW_2k as shown in FIG. 5C) and 4K, the variance of the output voltage Vₒᵤₜ as shown in FIG. 5C cannot be detected by the bandwidth in real time. The cause of the problem is that the bandwidth is insufficient. For solving the problem to detect the variance output voltage Vₒᵤₜ in real time, the bandwidth of the voltage loop feedback controller needs to be raised to 44K (BW_44k as shown in FIG. 5C). However, it is hard to implement the voltage loop feedback controller with the bandwidth of 44K. Similarly, the power supply corresponding to the voltage loop feedback controller is difficult to achieve and the system with the power supply will easily become unstable. Hence, the implementation is impracticable and fails to be widely utilized. Furthermore, according to the output current Iₒᵤₜ (line of Y2) as shown in FIG. 5C, when the output current Iₒᵤₜ and the output voltage Vₒᵤₜ are approximately changed at the period of 60 μs, the circuit using the bandwidth of 2 kHz significantly lags behind the phase variance of the output voltage Vₒᵤₜ.

Refer to FIG. 6, which is the circuit diagram using the comparator detecting the output dynamic response. The circuit in FIG. 6 comprises a power converter 21, an output capacitor Cₒᵤₜ, a load resistor R_{L}, a divider resistor 22, and a comparator 24. Similarly, the power converter 21 is electrically connected to the input power P, transfers the input signal of the input power P, and transmits the signal to the output capacitor Cₒᵤₜ and the load resistor R_{L}. When the divider voltage V_{FB} is generated via the output voltage Vₒᵤₜ divided by the divider resistor 22, the comparator 24 compares the divider voltage V_{FB} with a reference voltage V_{REF} to detect the variance of the output voltage Vₒᵤₜ. According to the aforementioned method, when the output voltage Vₒᵤₜ has been changed, the comparator 24 is able to compare the divider voltage V_{FB} with a reference voltage V_{REF} to detect the variance of the output voltage Vₒᵤₜ. However, this method is too late. That is, the method uses the divider voltage V_{FB} to detect the variance of the output voltage Vₒᵤₜ and trigger a command, but after a period, the output signal (output voltage Vₒᵤₜ) has been varied. As a result, the method utilizing the comparator 24 to detect the output dynamic response fails to achieve real-time detection such that the output voltage is lower than a regulation voltage specified by the power supply.

Accordingly, how to provide a power supply and a control method thereof to detect, in real time, the variance of the dynamic response and compensates the output signal is an urgent subject to tackle.

### SUMMARY OF THE INVENTION

In view of this, the present invention discloses a power supply and a control method thereof. The power supply comprises a power conversion unit, a current sampling circuit, and a signal comparison unit. The power conversion unit is configured to convert an input power into an output current. The power conversion unit has a power source output terminal for outputting the output current. The current sampling circuit is electrically connected to the power source output terminal of the power conversion unit and configured to sample a transient variation of the output current and generate an output voltage difference signal corresponding to a magnitude of the transient variation. The signal comparison unit is electrically connected to the current sampling circuit and configured to receive the output voltage difference signal, and compares the output voltage difference signal with a predetermined voltage value. When the output voltage difference signal is greater than or equal to the predetermined voltage value, the signal comparison unit generates a dynamic compensating command.

The present invention further discloses a control method for the power supply, comprising the following steps: converting an input power into an output current and outputting the output current by a power conversion unit; sampling the transient variation of the output current and generating an output voltage difference signal corresponding to a magnitude of the transient variation by a current sampling circuit; and receiving the output voltage difference signal and comparing the output voltage difference signal with a predetermined voltage value by a signal comparison unit; wherein when the output voltage difference signal is greater than or equal to the predetermined voltage value, the signal comparison unit generates a dynamic compensating command.

As mentioned above, the power supply and the control method thereof of the present invention utilize a current feedback signal as a trigger command. In other words, the power supply is triggered to generate a dynamic compensating command by detecting the variance of the voltage response (output voltage difference signal) of the dynamic current (output current). That is, when the variance of the voltage response (output voltage difference signal) of the dynamic current (output current) is abruptly varied, the power supply is triggered to generate a dynamic compensating command to the power converter. Accordingly, the power supply and the control method thereof compensate the output voltage to a range of a regulator voltage before the output voltage exceeds the range of the regulator voltage.

### BRIEF DESCRIPTION OF THE DRAWINGS

FIG. 1A is the block diagram of the power supply of the present invention;

FIG. 1B is the block diagram showing that the power supply current sampling circuit comprising a voltage signal converting unit, a voltage signal amplification unit, a voltage signal processing unit, and a signal difference unit;

FIG. 1C is the circuit diagram of the power supply in FIG. 1B;

FIG. 2 is the waveform variation diagram of the dynamic load response;

FIG. 3 is the flowchart of the power supply control method of the present invention;

FIG. 4A is the simulation schematic diagram using the analog circuit;

FIG. 4B is the schematic diagram of the simulation in FIG. 4A;

FIG. 5A is a diagram of a server power supply circuit for detecting an output dynamic response of the prior art;

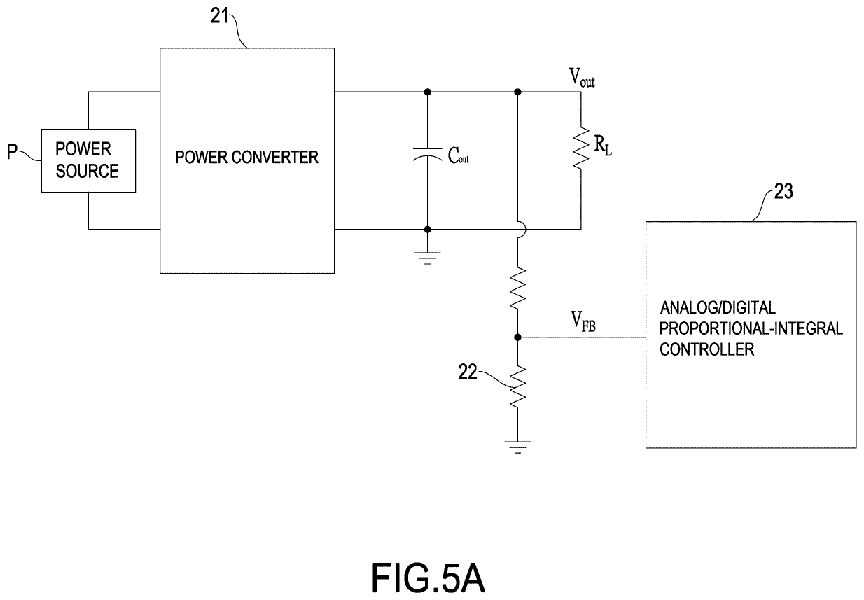

FIG. 5B is the simulation circuit of the voltage loop feedback signal in FIG. 5A;

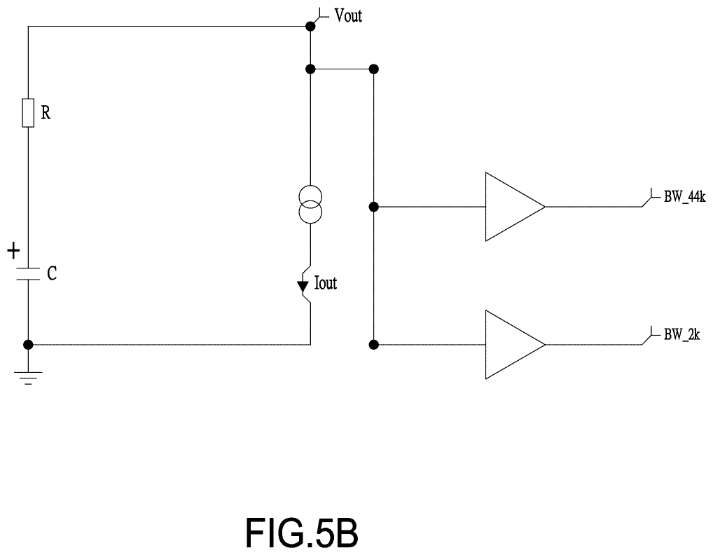

FIG. 5C is the schematic diagram for the circuit bandwidth relative to the drawn velocity of the current in FIG. 5A; and

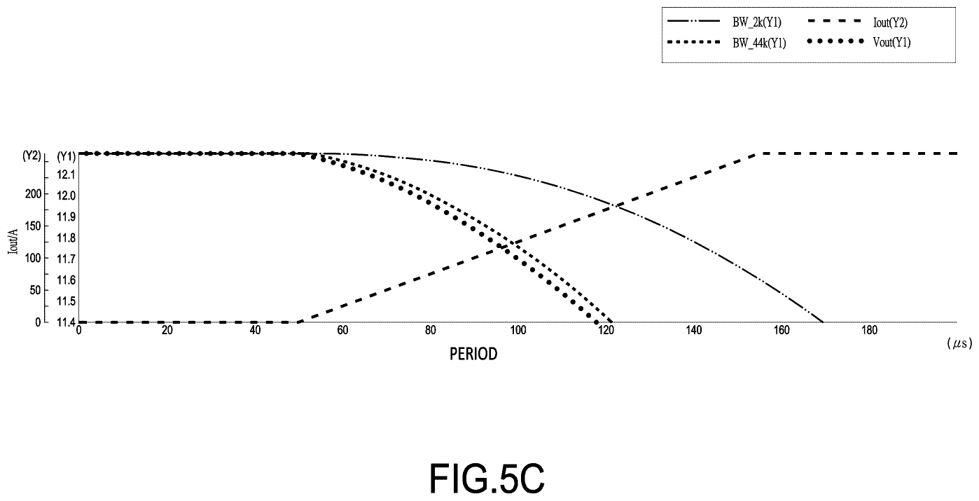

FIG. 6 is the circuit diagram using the comparator detecting the output dynamic response.

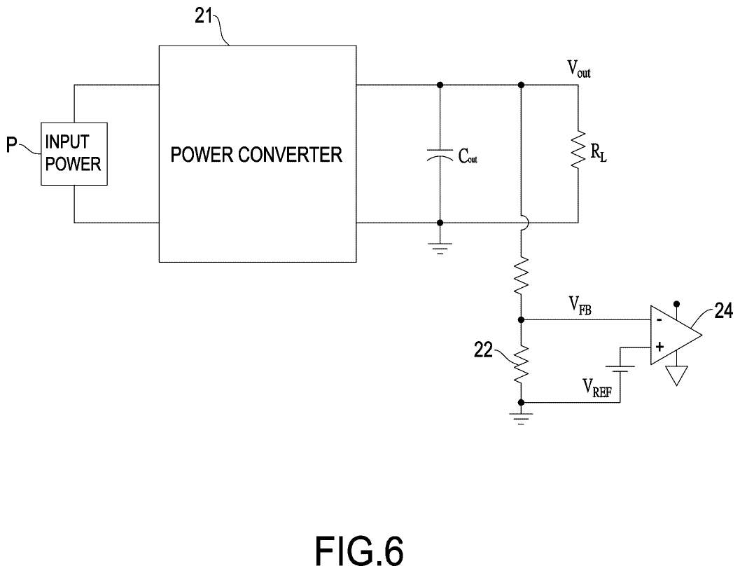

### DETAILED DESCRIPTION OF THE INVENTION

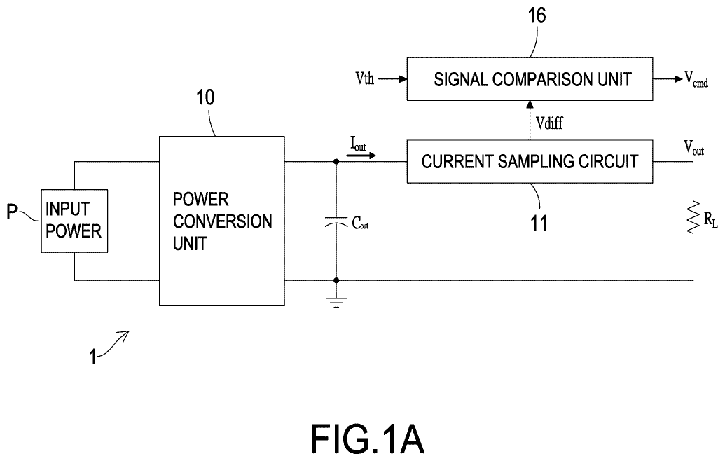

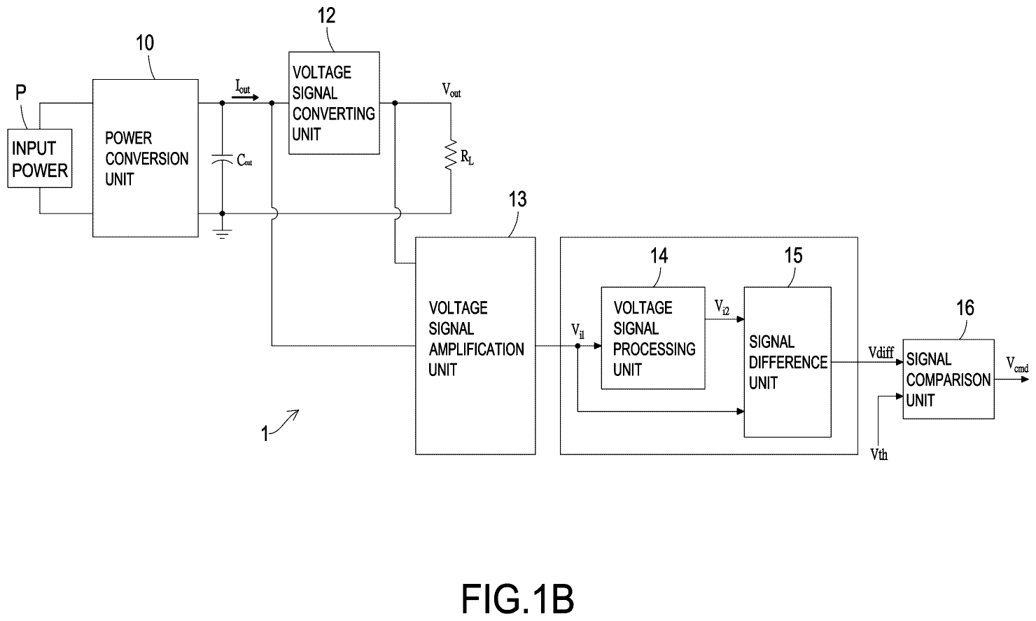

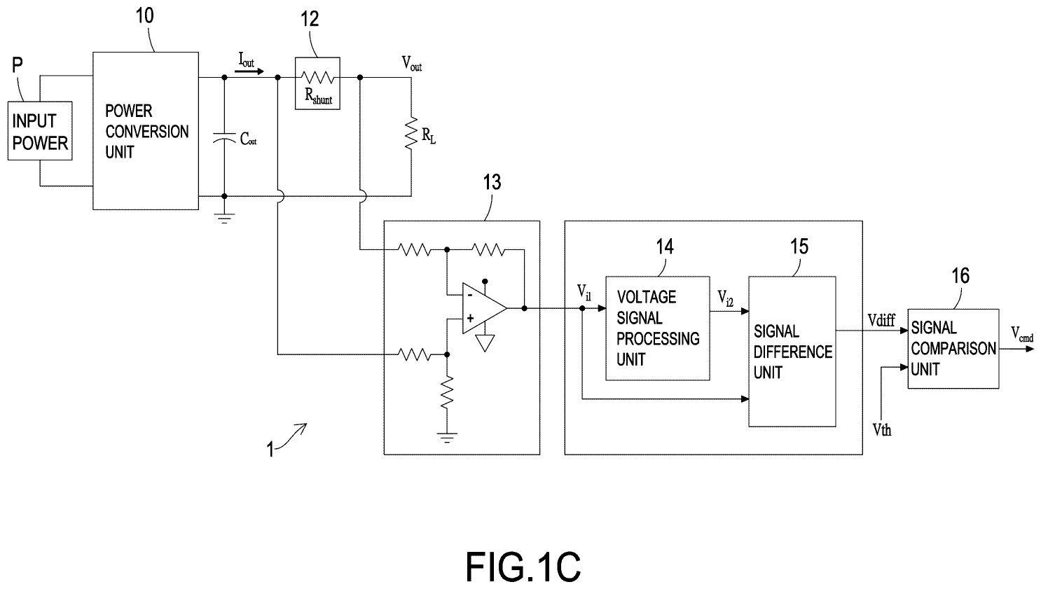

Refer to FIG. 1A, which is the block diagram of the power supply of the present invention. The power supply 1 comprises a power conversion unit 10, a current sampling circuit 11, and a signal comparison unit 16. The power conversion unit 10 converts power based on an input power P and generate an output current Iₒᵤₜ. The power conversion unit 10 has a power source output terminal and outputs the output current Iₒᵤₜ from the power source output terminal. The current sampling circuit 11 is electrically connected to the power source output terminal of the power conversion unit 10 to sample a transient variation of the output current Iₒᵤₜ and generates an output voltage difference signal V_{diff} corresponding to a magnitude of the transient variation. The signal comparison unit 16 is electrically connected to the current sampling circuit 11 to receive the output voltage difference signal V_{diff}. The signal comparison unit 16 compares the output voltage difference signal V_{diff} with a predetermined voltage value Vₜₕ. When the output voltage difference signal V_{diff} is greater than or equal to the predetermined voltage value Vₜₕ, the signal comparison unit 16 generates a dynamic compensating command V_{cmd}. In an embodiment of the present invention, the input power P comprises an electricity supply, a socket, or other power sources.

Refer to FIG. 1B. which is the block diagram showing that the power supply current sampling circuit comprises a voltage signal converting unit 12, a voltage signal amplification unit 13, a voltage signal processing unit 14, and a signal difference unit 15 in FIG. 1A. In the embodiment, the power supply 1 comprises a power conversion unit 10, a current sampling circuit 11, and a signal comparison unit 16. The current sampling circuit 11 comprises a voltage signal converting unit 12, a voltage signal amplification unit 13, a voltage signal processing unit 14, and a signal difference unit 15. The power conversion unit 10 is electrically connected to the input power P and transfers an input signal of the input power P to the output current Iₒᵤₜ. The power conversion unit 10 has a power source output terminal and outputs the output current Iₒᵤₜ from the power source output terminal. The input signal of the input power P comprises AC current or DC current. An output capacitor Cₒᵤₜ is disposed at the power source output terminal of the power conversion unit 10. The voltage signal converting unit 12 is electrically connected to the power source output terminal of the power conversion unit 10 and the load port to transfer the output current Iₒᵤₜ as the output voltage signal Vₒᵤₜ. A load resistor R_{L} is disposed at the load port. The voltage signal amplification unit 13 is electrically connected to the voltage signal converting unit 12, the load port, and the power source output terminal to amplify the output voltage signal Vₒᵤₜ and generates an amplified output voltage signal Vᵢ₁. The voltage signal processing unit 14 is electrically connected to the voltage signal amplification unit 13 to delay a change of the amplified output voltage signal Vᵢ₁ and generates a lagging output voltage signal Vᵢ₂. That is, the voltage signal processing unit 14 delays the amplified output voltage signal Vᵢ₁ so that the phase of the lagging output voltage signal Vᵢ₂ is lagged behind the phase of the amplified output voltage signal Vᵢ₁. The signal difference unit 15 is electrically connected to the voltage signal amplification unit 13, and the voltage signal processing unit 14 receives the amplified output voltage signal Vᵢ₁ and the lagging output voltage signal Vᵢ₂. After that, the signal difference unit 15 compares the amplified output voltage signal Vᵢ₁ with the lagging output voltage signal Vᵢ₂ to generate the output voltage difference signal V_{diff} to the signal comparison unit 16. The signal comparison unit 16 is electrically connected to the signal difference unit 15 to receive the output voltage difference signal V_{diff} and compares the output voltage difference signal V_{diff} with a predetermined voltage value Vₜₕ. When the output voltage difference signal V_{diff} is greater than or equal to the predetermined voltage value Vₜₕ, the signal comparison unit 16 generates a dynamic compensating command V_{cmd}.

Refer to FIG. 1C, which is the circuit diagram of the power supply in FIG. 1B. In an embodiment of the present invention, the voltage signal converting unit 12 comprises a shunt resistor Rₛₕᵤₙₜ or a Hall sensor. The voltage signal amplification unit 13 comprises a differential amplifier or a non-inverting amplifier. The voltage signal processing unit 14 comprises a low-pass filter, an active filter, a resistor-capacitor (RC) filter, or a digital filter. The voltage signal processing unit 14 filters the amplified output voltage signal Vᵢ₁ to generate the lagging output voltage signal Vᵢ₂. The digital filter filters the amplified output voltage signal Vᵢ₁ to generate the steady average of the lagging output voltage signal Vᵢ₂. The signal difference unit 15 compares the amplified output voltage signal Vᵢ₁ with the steady average of the lagging output voltage signal Vᵢ₂ to generate the output voltage difference signal V_{diff}. The signal difference unit 15 comprises a differential amplifier, an analog comparator, or a digital comparator. The signal comparison unit 16 comprises an analog comparator, a Schmidt hysteresis circuit, or a digital comparator.

In an embodiment of the present invention, the voltage signal processing unit 14 comprises a memory unit, storing and averaging the plurality of amplified output voltage values of the amplified output voltage signal Vᵢ₁ and generating the lagging output voltage average of the lagging output voltage signal Vᵢ₂ according to the plurality of amplified output voltage values. The signal difference unit 15 compares the amplified output voltage signal Vᵢ₁with the lagging output voltage average of the lagging output voltage signal Vᵢ₂ to generate the output voltage difference signal V_{diff}. In an embodiment of the present invention, the memory unit is a register, storing a plurality of the amplified output voltage values Vᵢ₁ with a predetermined sampling frequency. For instance, the memory unit stores the plurality of amplified output voltage values Vᵢ₁ with the predetermined sampling frequency per second.

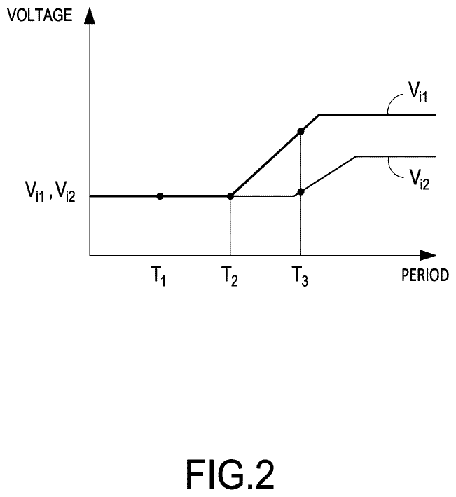

Refer to FIG. 2, which is the waveform variation diagram of the dynamic load response. As shown in FIG. 2, when the output current Iₒᵤₜ is hugely drawn at the load port and the amplified output voltage signal Vᵢ₁ fails to be delayed by the voltage signal processing unit 14, the dynamic load response is abruptly varied. After the voltage signal processing unit 14 filters or averages the amplified output voltage signal Vᵢ₁, the amplified output voltage signal Vᵢ₁ is slowly changed. Accordingly, the lagging output voltage signal Vᵢ₂ is generated by the amplified output voltage signal Vᵢ₁ lagged via the voltage signal processing unit 14. Moreover, the memory unit separately captures and stores the values of the amplified output voltage signal Vᵢ₁ and the values of the lagging output voltage signal Vᵢ₂ at different periods such as a first period T1, a second period T2, and a third period T3 and compares the values. Take the first period T1 and the second period T2 as an example: the amount of variance between the amplified output voltage signal Vᵢ₁ and the lagging output voltage signal Vᵢ₂ at the first period T1 is the same as that at the second period T2, i.e., no variance between the amplified output voltage signal Vᵢ₁ and the lagging output voltage signal Vᵢ₂. Consequently, the output voltage difference signal V_{diff} generated by the signal difference unit 15 fails to be greater than or equal to the predetermined voltage value Vₜₕ. However, at the third period T3, since the variance between the amplified output voltage signal Vᵢ₁ and the lagging output voltage signal Vᵢ₂ is greater than the variances between the amplified output voltage signal Vᵢ₁ and the lagging output voltage signal Vᵢ₂ at the second period T1 and the second period T2, the output voltage difference signal V_{diff} generated by the signal difference unit 15 increases. Hence, after the signal comparison unit 16 compares the output voltage difference signal V_{diff} with the predetermined voltage value Vₜₕ and the output voltage difference signal V_{diff} is greater than or equal to the predetermined voltage value Vₜₕ, the output current Iₒᵤₜ at the load port is being hugely drawn at the period T3. Therefore, the signal comparison unit 16 performs a dynamic compensating mechanism to generate the dynamic compensating command V_{cmd}.

As mentioned above, the memory unit stores a plurality of the amplified output voltage values. After that, the signal difference unit 15 compares at least one amplified output voltage value in the plurality of the amplified output voltage values with the lagging output voltage signal Vᵢ₂ to generate at least one output voltage difference signal V_{diff}. The signal comparison unit 16 receives the at least one output voltage difference signal V_{diff} and compares the at least one output voltage difference signal V_{diff} with the predetermined voltage value Vₜₕ. When the at least one output voltage difference signal V_{diff} is greater than or equal to the predetermined voltage value Vₜₕ, the signal comparison unit 16 generates at least one dynamic compensating command V_{cmd}. Furthermore, when the signal comparison unit 16 generates multiple dynamic compensating commands V_{cmd} according to the aforementioned results, the signal comparison unit 16 preforms multiple compensations at multiple periods. For example, when generating three dynamic compensating commands V_{cmd}, the signal comparison unit 16 outputs the three dynamic compensating commands V_{cmd} to preform three compensations at three periods.

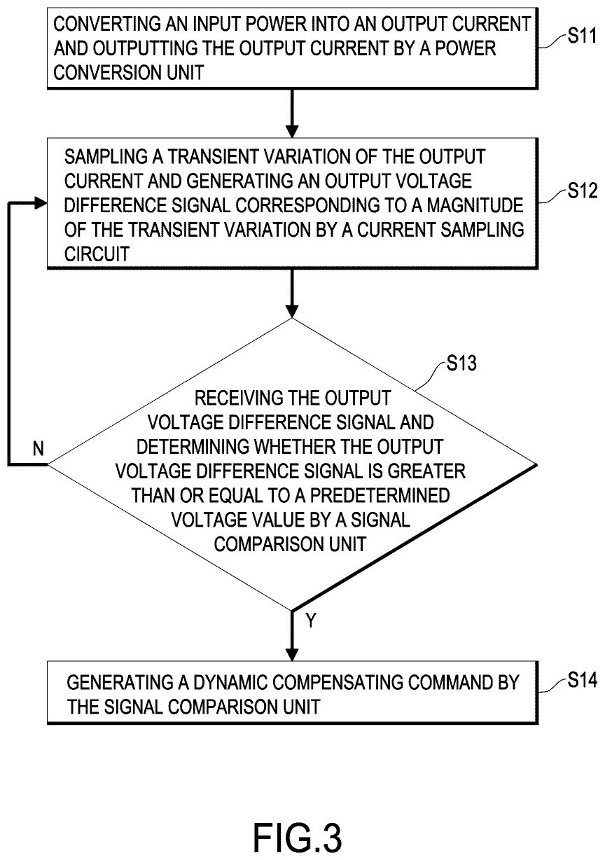

Refer to FIG. 3. which is the flowchart of the power supply control method of the present invention. The power supply control method comprises the following steps: in step S11, converting an input power into an output current and outputting the output current by a power conversion unit; in step S12, sampling a transient variation of the output current and generating an output voltage difference signal corresponding to a magnitude of the transient variation by a current sampling circuit; in step S13, receiving the output voltage difference signal and determining whether the output voltage difference signal is greater than or equal to a predetermined voltage value by a signal comparison unit; wherein when the output voltage difference signal is greater than or equal to the predetermined voltage value, performing step S14 in which the signal comparison unit generates a dynamic compensating command; when the output voltage difference signal is not greater than or is equal to the predetermined voltage value, returning to step S12.

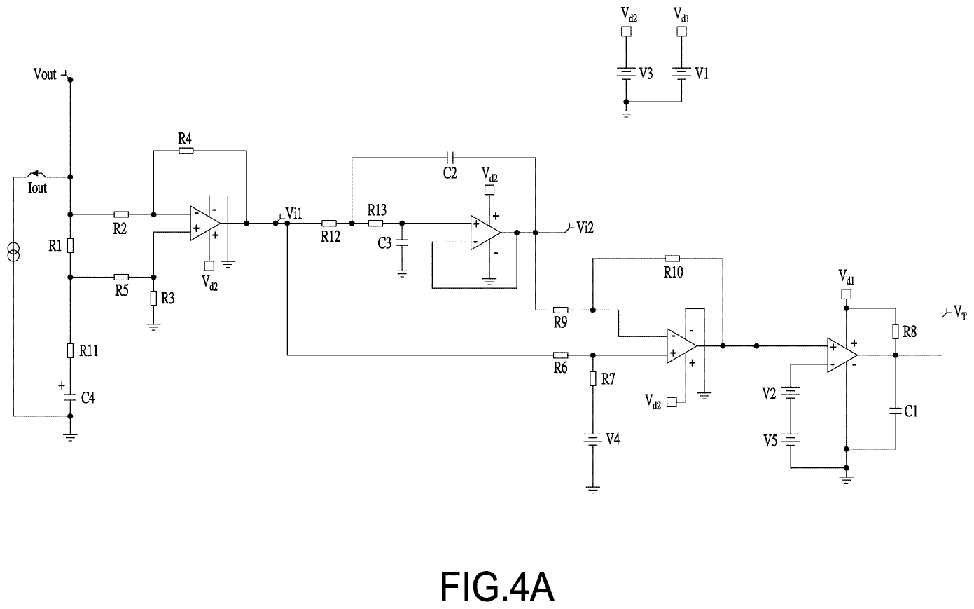

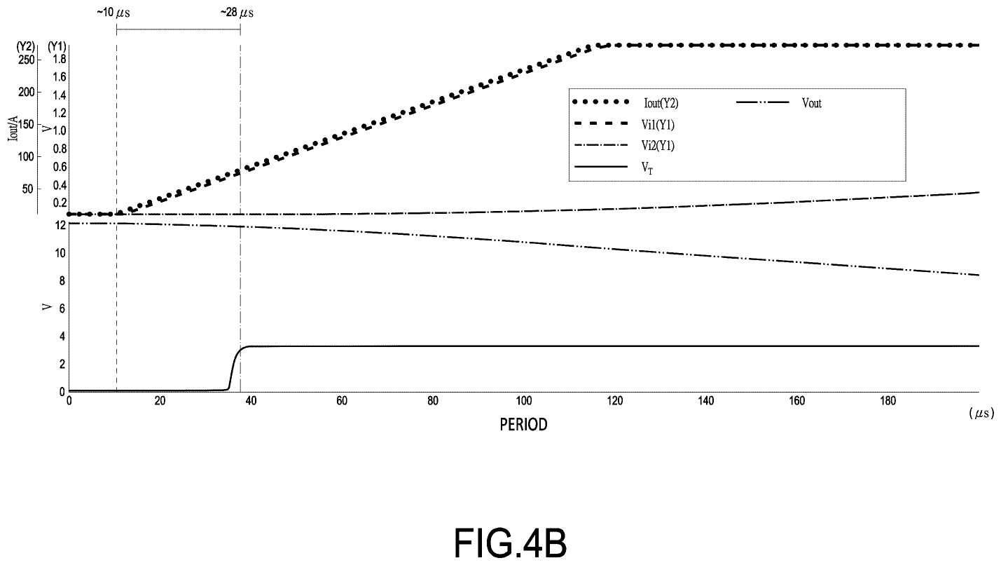

Referring to FIG. 4A and FIG. 4B, FIG. 4A is the simulation schematic diagram using the analog circuit and FIG. 4B is the schematic diagram of the simulation in FIG. 4A. In the embodiment of the present invention, a digital control circuit is able to implement the circuit of the power supply in FIG. 1C but it is not limited to an analog circuit. The simulation for the load in FIG. 4A is set to reach 200 A with the variance of 2.5 A/μs. Moreover, when the load reaches the negative tolerance of 50 A, the dynamic compensation controlling mode is triggered. As shown in FIG. 4B, the solid line illustrates that the signal in the load has been varied after 20 μs approximately, thereby triggering the dynamic response V_{T}. Generally, the condition that the signal at the load port has been changed is determined after at least 60 μs. In this way, the response detected by the power supply and the control method thereof in the present invention is faster than the response detected by the voltage loop feedback controller in the prior art. It should be noted that the simulation in FIG. 4A and FIG. 4B utilized to illustrate the power supply in the embodiment of the present invention is significantly superior to the method of the prior art for detecting the output signal. In other words, the response detected by the power supply and the control method thereof in the present invention is faster than the response detected by the circuit and the method thereof in the prior art. Consequently, the output current controlled by the power supply is more stable. Furthermore, the specific value of each resistor R1˜R13, capacitor C1˜C4, voltage V1˜V5, V_{d1},V_{d2},Vₒᵤₜ, V_{T}, current Iₒᵤₜ, and period in FIG. 4A and FIG. 4B are utilized to illustrate, but not to limit, the embodiment in the present invention.

In summary, the power supply and the control method thereof of the present invention utilize a current feedback signal as a trigger command. In other words, the power supply is triggered to generate a dynamic compensating command by detecting the variance of the voltage response (output voltage difference signal) of the dynamic current (output current). That is, when the variance of the voltage response (output voltage difference signal) of the dynamic current (output current) is abruptly varied, the power supply is triggered to generate a dynamic compensating command to the power converter. Accordingly, the power supply and the control method thereof compensate the output voltage to a range of a regulator voltage before the output voltage exceeds the range of the regulator voltage.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A power supply, comprising:
a power conversion unit, configured to convert an input power into an output current; wherein the power conversion unit has a power source output terminal for outputting the output current;
a current sampling circuit, electrically connected to the power source output terminal of the power conversion unit and configured to sample a transient variation of the output current and generate an output voltage difference signal corresponding to a magnitude of the transient variation; and
a signal comparison unit, electrically connected to the current sampling circuit, and configured to receive the output voltage difference signal and compare a predetermined voltage value with the output voltage difference signal;
wherein when the output voltage difference signal is greater than or equal to the predetermined voltage value, the signal comparison unit generates a dynamic compensating command.

2. The power supply as claimed in claim 1, wherein the current sampling circuit comprises:
a voltage signal converting unit, electrically connected to the power source output terminal of the power conversion unit and configured to convert the output current into an output voltage signal;
a voltage signal amplification unit, electrically connected to the voltage signal converting unit and configured to amplify the output voltage signal to generate an amplified output voltage signal;
a voltage signal processing unit, electrically connected to the voltage signal amplification unit and configured to delay a change of the amplified output voltage signal to generate a lagging output voltage signal; and
a signal difference unit, electrically connected to the voltage signal amplification unit and the voltage signal processing unit and configured to receive and compare the amplified output voltage signal with the lagging output voltage signal to generate the output voltage difference signal to the signal comparison unit.

3. The power supply as claimed in claim 2, wherein the voltage signal converting unit comprises a shunt resistor or a Hall sensor.

4. The power supply as claimed in claim 2, wherein the voltage signal amplification unit comprises a differential amplifier or a non-inverting amplifier.

5. The power supply as claimed in claim 2, wherein the voltage signal processing unit comprises a low-pass filter, an active filter, a resistor-capacitor (RC) filter or a digital filter, filtering the amplified output voltage signal to generate the lagging output voltage signal.

6. The power supply as claimed in claim 2, wherein the voltage signal processing unit comprises a digital filter configured to filter the amplified output voltage signal to generate a steady average of the lagging output voltage signal;
wherein the signal difference unit is further configured to compare the amplified output voltage signal with the steady average of the lagging output voltage signal to generate the output voltage difference signal.

7. The power supply as claimed in claim 2, wherein the signal difference unit comprises a differential amplifier, an analog comparator, or a digital comparator.

8. The power supply as claimed in claim 1, wherein the signal comparison unit comprises an analog comparator, a Schmidt hysteresis circuit, or a digital comparator.

9. The power supply as claimed in claim 2, wherein the voltage signal processing unit comprises a memory unit configured to store and average a plurality of amplified output voltage values of the amplified output voltage signal to generate a lagging output voltage average of the lagging output voltage signal according to the plurality of amplified output voltage values;
wherein the signal difference unit is further configured to receive and compare the amplified output voltage signal with the lagging output voltage average of the lagging output voltage signal to generate the output voltage difference signal.

10. The power supply as claimed in claim 9, wherein the memory unit stores the plurality of amplified output voltage values with a predetermined sampling frequency.

11. A control method for a power supply, comprising steps as follows:
converting an input power into an output current and outputting the output current by a power conversion unit;
sampling a transient variation of the output current and generating an output voltage difference signal corresponding to a magnitude of the transient variation by a current sampling circuit; and
receiving the output voltage difference signal and comparing the output voltage difference signal with a predetermined voltage value by a signal comparison unit;
wherein when the output voltage difference signal is greater than or equal to the predetermined voltage value, the signal comparison unit generates a dynamic compensating command.

12. The control method for the power supply as claimed in claim 11, wherein the step for sampling the transient variation of the output current by the current sampling circuit comprises the following steps:
transferring the output current to an output voltage signal and outputting the output current by a voltage signal converting unit;
amplifying the output voltage signal to generate an amplified output voltage signal by a voltage signal amplification unit;
delaying a change of the amplified output voltage signal to generate a lagging output voltage signal by a voltage signal processing unit; and
receiving and comparing the amplified output voltage signal with the lagging output voltage signal by a signal difference unit to generate the output voltage difference signal to the signal comparison unit.

13. The control method for the power supply as claimed in claim 12, wherein the voltage signal converting unit comprises a shunt resistor or a Hall sensor.

14. The control method for the power supply as claimed in claim 12, wherein the voltage signal amplification unit comprises a differential amplifier or a non-inverting amplifier.

15. The control method for the power supply as claimed in claim 12, wherein the voltage signal processing unit comprises a low-pass filter, an active filter, a resistor-capacitor (RC) filter or a digital filter, filtering the amplified output voltage signal to generate the lagging output voltage signal.

16. The control method for the power supply as claimed in claim 15, wherein the voltage signal processing unit comprises a digital filter configured to filter the amplified output voltage signal to generate a steady average of the lagging output voltage signal;
wherein the signal difference unit is further configured to compare the amplified output voltage signal with the steady average of the lagging output voltage signal to generate the output voltage difference signal.

17. The control method for the power supply as claimed in claim 12, wherein the signal difference unit comprises a differential amplifier, an analog comparator, or a digital comparator.

18. The control method for the power supply as claimed in claim 11, wherein the signal comparison unit comprises an analog comparator, a Schmidt hysteresis circuit, or a digital comparator.

19. The control method for the power supply as claimed in claim 12, wherein the voltage signal processing unit comprises a memory unit configured to store and average a plurality of amplified output voltage values of the amplified output voltage signal to generate a lagging output voltage average of the lagging output voltage signal according to the plurality of amplified output voltage values;
wherein the signal difference unit is further configured to receive and compare the amplified output voltage signal with the lagging output voltage average of the lagging output voltage signal to generate the output voltage difference signal.

20. The control method for the power supply as claimed in claim 19, wherein the memory unit stores the plurality of amplified output voltage values with a predetermined sampling frequency.
